(19) United States
(12) Patent Application Publication
(10) Pub. No.: US 2019/0091887 A1
(43) Pub. Date: Mar. 28, 2019

(54) Continuous Motion Induction Sealer Rotary Die & Vacuum Conveyor

(71) Applicant: DEL PACKAGING, LTD., Tomball, TX (US)

(72) Inventors: Ramon A SALAZAR, Tomball, TX (US); Michael G. MYLIUS, Tomball, TX (US)

(21) Appl. No.: 15/761,834

(22) PCT Filed: Jun. 14, 2016
(86) PCT No.: PCT/US2016/037349

§ 371 Date: Mar. 21, 2018

(51) Int. Cl. B26D 7/18; B26F 1/38; B65B 7/28; B65H 20/02; B65H 35/08; B26D 7/20

(52) U.S. Cl. CPC B26D 7/1863; B26F 1/3846; B65B 7/2807; B65B 7/2878; B65H 20/02; B65H 35/08; B65H 2701/1752; B65H 2301/51538; B65H 2406/3124; B65H 2406/321; B65H 2406/33; B65H 2406/3612; B26D 7/204

(57) ABSTRACT

A continuous motion induction sealer rotary die and vacuum conveyor operates by pulling film thorough a rotary die assembly comprising a die and anvil geared together to rotate against each other cutting film patches from the film and securing them to the anvil surface via a vacuum pressure. The anvil then continues rotating to deposit the film patches onto a vacuum conveyor releasing the anvil vacuum to facilitate the transfer. The vacuum conveyor then conveys the film patches to an induction seal head and directs air pressure under the patch to transfer it to the induction seal head which secures the film patch via vacuum pressure while transferring and sealing the film patch to a container.

### BACKGROUND OF THE INVENTION

This invention relates generally the sealing of containers and more particularly to the process of producing and positioning membrane seals to one or more container sealers of containers of the type used to hold food products in a continuous fashion.

The process of utilizing heat induction to hermetically sealed food containers has been in practice as described in U.S. Pat. No. 3,460,310, granted Aug. 12, 1969. It has been refined many times including the use of single die cutting, vacuum positioning, and heat sealing heads described by Parsons in his U.S. Pat. No. 4,625,498, granted Dec. 2, 1986. Boatwright, et al. discussed in their U.S. Pat. No. 6,478,218, granted Nov. 12, 2002, and U.S. Pat. No. 6,829,874, granted Dec. 14, 2004, the use of pre-shaped end closures to cushion, in a “pillow-like” manner, to secure fragile contents.

The previous methods of creating and/or sealing such containers have faced the same problem; the speed of the process is limited by the complexity of handling the membrane material and properly positioning the material to achieve a hermetic seal. Previous solutions have required the cutters and induction heads be a single unit resulting in a more costly operation and more difficulty in replacing cutters, use capping receivers to transfer the membrane and cap assembly to the container, utilizing the cap to position the membrane, or utilizing vacuum receivers to continuously hold a membrane for positioning on the container, requiring precise synchronization between cutters and sealers.

### BRIEF DESCRIPTION OF THE DRAWINGS

FIG. 1 shows a continuous motion induction sealer rotary die and vacuum conveyor in accordance with an exemplary embodiment of the invention.

FIG. 1A shows a vacuum conveyor table in accordance with an exemplary embodiment of the invention.

FIG. 2 shows a rotary die cutter depositing membrane patches on a conveyor table in accordance with an exemplary embodiment of the invention.

FIG. 2A shows a cross section of the rotary die cutter and the manifold arrangement internal to the anvil drum, providing vacuum transfer to the conveyor table in accordance with an exemplary embodiment of the invention.

FIG. 2B shows the anvil blower in accordance with an exemplary embodiment of the invention.

FIG. 3 shows an induction seal head receiving membrane patches from the vacuum conveyor table in accordance with an exemplary embodiment of the invention.

### DETAILED DESCRIPTION OF THE PREFERRED EMBODIMENTS

In the present innovation, a rotary die assembly incorporates a rotary die geared together with an anvil allowing continuous cutting of membrane material for deposit on a vacuum table. The anvil further includes a plurality of holes on the surface connected to a plurality of manifolds located on the internal side of the anvil's roller surface. The manifolds may be utilized to induce a vacuum or positive pressure to the surface of the anvil at different orientations during the rotation process. The anvil rotates against the die with the membrane film passing there between. Ports on the anvil, with a vacuum induced by manifolds connected thereto, hold the membrane as the die cuts a patch, allowing the anvil to separate the membrane patch from the membrane sheet, leaving a membrane skeleton to be recycled or disposed.

In the preferred embodiment, the holes in the surface of the anvil are positioned such that they are located internal to the die. In another embodiment the holes may be located external to the patch. In another embodiment holes may be located both internal and external to the die, and those holes may be connected to differing manifolds depending on whether the holes are located internal to the die or external to the die.

In one embodiment the manifolds may be utilized to blow pressurized air through the holes to force the membrane away from the surface of the anvil. In another embodiment the manifolds may be utilized to produce a vacuum at the holes and hold the membrane to the surface of the anvil. In another embodiment both vacuum and pressure may be utilized on different holes depending on their location with respect to the die cuts.

As the anvil rolls against the die roller, cutting the membrane in the process, different manifolds internal to the anvil are connected to the anvil blower which has high and low pressure ports to blow pressure or draw from the anvil a vacuum at the surface holes. The vacuum thus created behind the membrane patch secures the patch as the anvil drum continues rolling down to the conveyor.

At the point where the anvil drum meets the conveyor, the manifolds internal to the anvil are disconnected from the vacuum draw of the anvil blower, and the perforations of the conveyor belt are exposed to the vacuum zone of the conveyor table. This changing of vacuum pressure transfers the membrane patch from the anvil drum to the conveyor belt. In one embodiment, the anvil manifolds may be connected to pressure to further facilitate the transfer of the membrane patch to the conveyor.

The conveyor incorporates a plurality of zones in the frame of the table which are connected to blowers or manifolds to produce a negative pressure (a vacuum) or a positive pressure under the belt which wraps around the table frame and is driven by the table's belt rollers. As the belt passes along the side of the table, holes passing through the belt are exposed to the vacuum, or positive pressure of the inside table frame and thus secure or remove membrane patches to, or blow membrane patches from, the surface of the belt.

In one embodiment, the vacuum patch remains secured to the conveyor belt until the patch is conveyed to the induction seal head via the vacuum region of the table. Once the patch reaches the induction seal head, the vacuum of the table may be released to convey the membrane patch to the induction seal head. In one embodiment this transfer to the induction seal head may be facilitated by a vacuum pressure induced by the induction seal head. In another embodiment the table vacuum may be replaced with a positive pressure. In another embodiment, a secondary vacuum at the induction head stronger than that of the conveyor table may overcome the vacuum of the conveyor table, and urge the membrane patch toward the induction seal head.

In the preferred embodiment, film is pulled through a rotary die assembly as a die and anvil, geared together, rotate against each other. Film patches are cut in the film as it passes between the die and anvil. As the patch is cut in the film it is pulled out of the film skeleton by the vacuum present in the anvil vacuum holes.

The anvil and die rotation speed accelerates and decelerates to match the vacuum belt holes patterns spacing to the patch. As the anvil rotates with the patch attached, it brings the patch onto the top of the vacuum conveyor aligned with the vacuum belt holes pattern. The vacuum-air manifold, attached to the anvil end face, opens and closes vacuum ports and pressure ports as the anvil end face rotates against it.

The patch is transferred from the anvil to the vacuum conveyor belt as the vacuum-air manifold switches the anvil ports from vacuum to pressure. While the patch is transported by the vacuum conveyor to the induction seal head, it is blown off the vacuum conveyor while simultaneously being picked up by the vacuum in the induction seal head. This is accomplished by the vacuum conveyor solenoid valve direction air pressure underneath the patch when it is directly underneath the induction seal head.

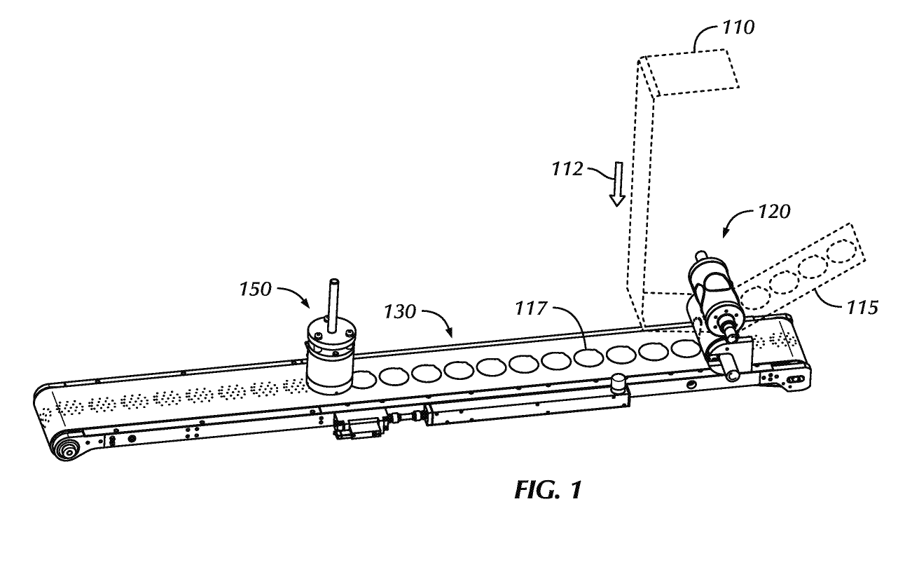

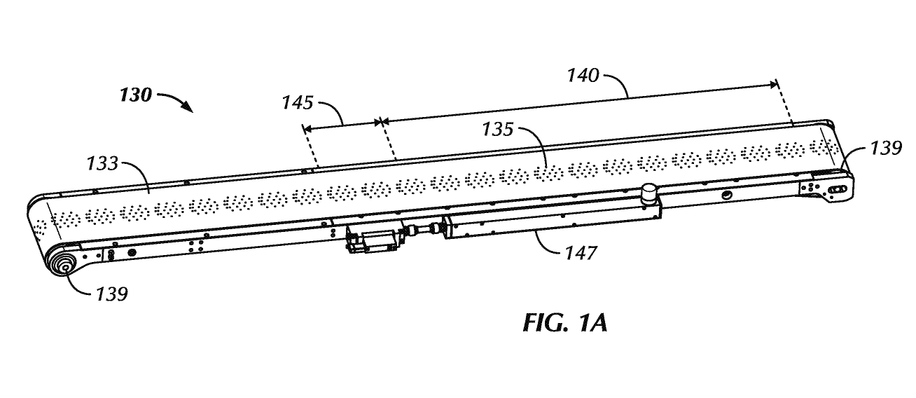

FIG. 1 shows a continuous motion induction sealer rotary die and vacuum conveyor in accordance with an exemplary embodiment of the invention. The continuous motion induction sealer rotary die and vacuum conveyor 100 is comprised of a membrane sheet 110, which is fed in the direction indicated 112 to a rotary cutter assembly (cutter assembly) 120.

The cutter assembly 120 cuts membrane patches (patches) 117 from the membrane sheet 110 and separates and discards the remaining membrane skeleton. The patches 117 are transferred to a vacuum conveyor assembly (conveyor) 130. The conveyor 130 conveys the patches 117 to an induction seal head (sealer) 150.

FIG. 1A shows a vacuum conveyor table in accordance with an exemplary embodiment of the invention. The conveyor 130 has a frame 145 with a plurality of zones 140,145 which may be pressurized positive or negative by manifolds and blowers 147. End rollers 139 allow a belt 133 to pass around the outside of the table frame 145 where holes 135 are exposed to vacuum zones 140, and blower zones 145 which may be continuously operated or sporadically operated to produce vacuum or positive pressure at the holes 135 of the belt's 133 outer surface.

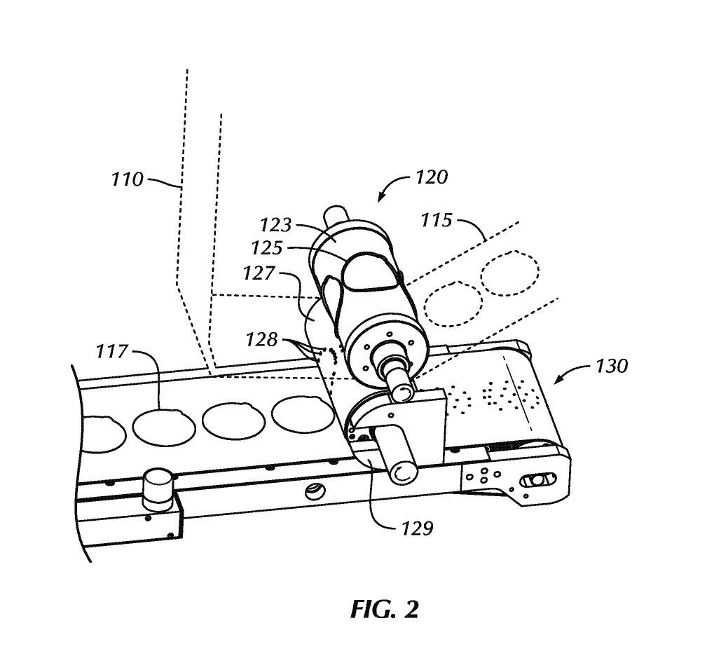

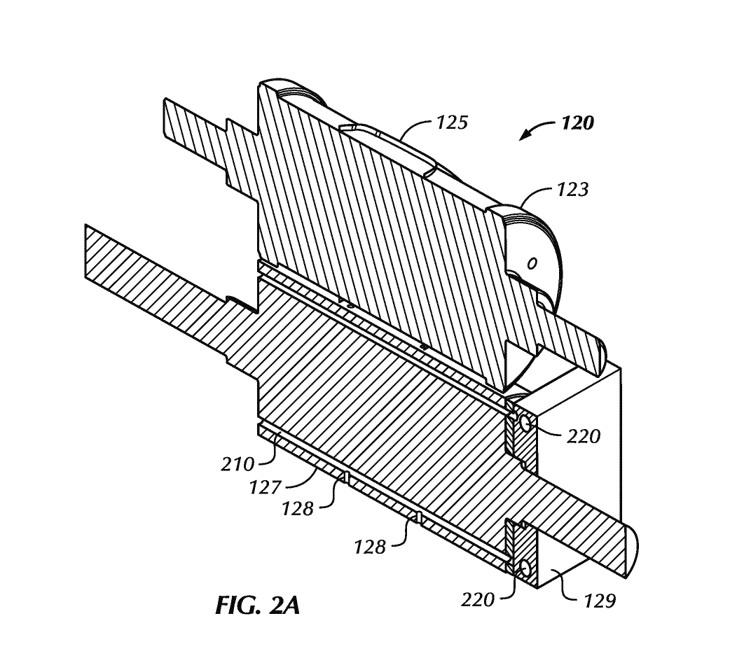

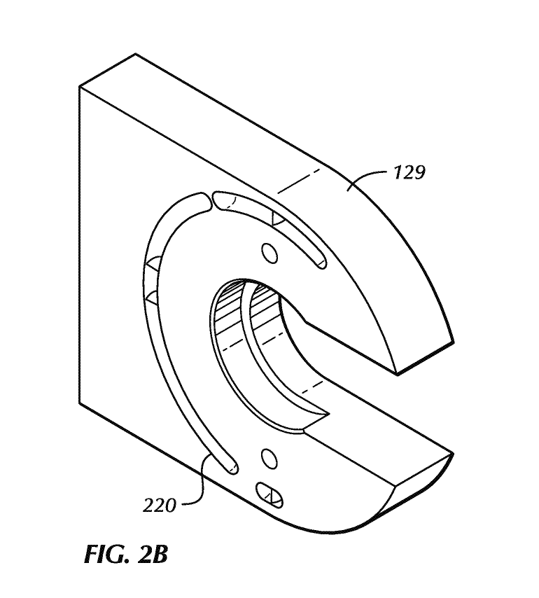

FIG. 2 shows a rotary die cutter depositing membrane patches on a conveyor table in accordance with an exemplary embodiment of the invention. The rotary die cutter assembly 120 is comprised of a die roller 123 and an anvil roller 127. The die roller 123 comprises one or more die cutters 125 extending from the surface.

The anvil roller 127 comprises one or more hole patterns 128 connected to manifolds (internal and not visible) which extend to one end and mate with an anvil blower 129 which produces positive and/or negative pressure at one or more of the holes in the hole patterns 128 on the surface of the anvil roller 127.

A membrane sheet 110 passes between the anvil roller 127 and the die roller 123, which cut patches 117 from the membrane sheet 110 and discard the membrane skeleton 115. The patches 117 adhere to the anvil roller 127 via the vacuum at the holes in the hole pattern 128 until the anvil roller 127 rotates to the belt surface of the vacuum conveyor 130 and are deposited thereon.

FIG. 2A shows a cross section of the rotary die cutter and the manifold arrangement internal to the anvil drum providing vacuum transfer o the conveyor table in accordance with an exemplary embodiment of the invention. The die roller 123 shown in the preferred embodiment is substantially hollow, with cutting dies 125 projecting to the outside. In another embodiment the die roller 123 may be solid, or have internal supporting structure, or may comprise holes and manifolds similar to the anvil roller 127.

The anvil roller 127 comprises a hollow drum with a plurality of perforations or holes (holes) 128 in the surface. The holes 128 may be connected to one or more manifolds 210 which extend to the side of the roller's 127 drum where they may engage and disengage with high and low pressure ports 220 on the anvil blower 129.

FIG. 2B shows the anvil blower in accordance with an exemplary embodiment of the invention. The anvil blower 129 incorporates or connects with blowers which produce high and/or low pressure at the ports 220 which mate with the manifolds 210 (not shown), of the anvil roller 127 (not shown).

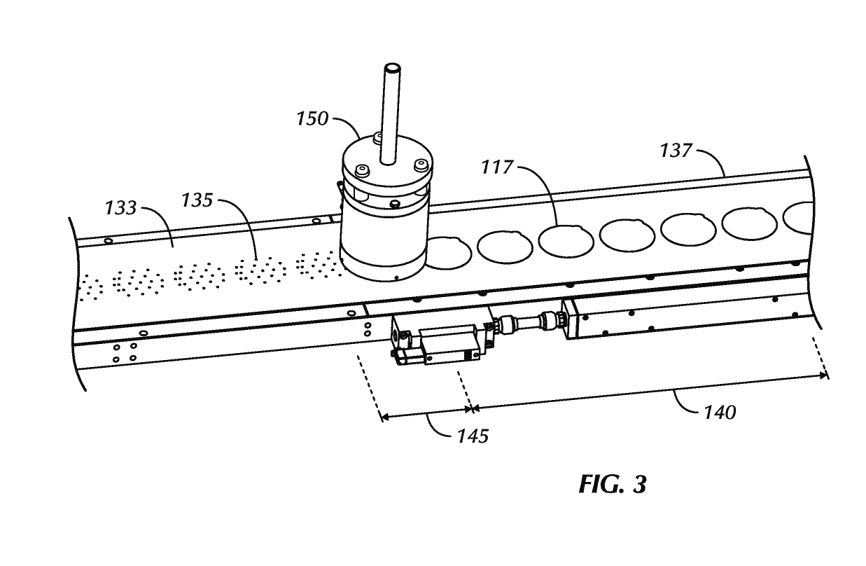

FIG. 3 shows an induction seal head receiving membrane patches from the vacuum conveyor table in accordance with an exemplary embodiment of the invention. The table 137 conveys patches 117 from the cutter assembly 120 (not shown) to the induction seal head 150.

The patches 117 are secured to the surface of the belt 133 by a vacuum at the holes patterns 135 while the belt passes over the vacuum zone 140. The patch leaves the vacuum zone 140 as it passes to the induction head 150 where the blower zone 145 may blow the patch to the induction seal head 150.

One skilled in the art will appreciate that the force of the positive air pressure, the force of the vacuum, and the specific hole patterns, sizes, and die shapes are dependent on the thickness of the membrane, the speed of the operations, and other variables which are determined by the specific operational environment and the specific configurations shown herein should be in no way limiting on the innovation described. Further, the precise location of the vacuum zones and/or the blowing zones are similarly operationally dependent and should not be limited to the specific embodiments illustrated or described herein.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally, some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

The above discussion is meant to be generally illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A sealing machine comprising;
A rotary die assembly; and
an anvil;
wherein the anvil employs vacuum pressure to remove cut material from the rotatable die assembly

2. A sealing machine as set forth in claim 1, wherein the anvil further employs positive pressure to separate the material from the anvil.

3. A sealing machine as set forth in claim 1, wherein the anvil produces vacuum or positive air pressure via manifolds within the anvil which exit to ports on the surface of the anvil, wherein the manifolds may be used to blow air from or draw air, dependent on the location of their exit ports on the surface of the anvil.

4. A sealing machine comprising;
A conveyor;
A die assembly; and
An anvil, wherein the conveyor carries a sheet of material to said die assembly, and the anvil produces a vacuum to transfer material cutouts produced by the die assembly from the die assembly to the anvil.

5. A sealing machine as set forth in claim 3, wherein the anvil may further employ positive air pressure to release the material cutouts.

6. A sealing machine as set forth in claim 3 wherein the die assembly is a rotary die assembly, and the anvil rotates against the die to cut and transfer the material.

7. A sealing machine as set forth in claim 3 wherein the anvil produces vacuum effects through holes located on the surface of the anvil.

8. A sealing machine as set forth in claim 3 wherein the anvil further transfers the material cutout to a second conveyor.

9. A sealing machine as set forth in claim 7, wherein the anvil further produces positive pressure as the material cutout is transferred to the conveyor.

10. A sealing machine as set forth in claim 7, wherein the conveyor produces areas of vacuum or positive pressure to direct retainage or release of the material cutout.

11. A sealing machine as set forth in claim 9, wherein the conveyor uses directed air press to transfer the material cutout to an induction seal head.

12. A sealing machine as set forth in claim 11 where the second conveyor has a variable speed such that the speed of the anvil need not match the speed of the sealing head.

13. A conveyor connecting a rotary die assembly and anvil and a sealing head, wherein the conveyor may run at variable speeds so that the speed of the sealing head need not match the speed of the anvil.

14. A conveyor as set forth in claim 13, wherein the anvil further employs vacuum and positive air pressure to transfer or release cut material onto the conveyor.

15. A conveyor as set forth in claim 13, wherein the conveyor produces a vacuum to facilitate transfer of material carried by the anvil to the surface of the conveyor.
